(19) United States
(12) Patent Application Publication
(10) Pub. No.: US 2012/0011654 A1
(43) Pub. Date: Jan. 19, 2012

(54) TABLE BACK FOR EXAMINATION TABLE

(75) Inventors: Dale Albers, Maria Stein, OH (US); Matt Tangeman, New Bremen, OH (US); Jordan Yoder, Troy, OH (US)

(73) Assignee: MIDMARK CORPORATION, Versailles, OH (US)

(21) Appl. No.: 12/836,267

(22) Filed: Jul. 14, 2010

(51) Int. Cl. A61G 15/04; B23P 11/00

(52) U.S. Cl. 5/617; 29/428

(57) ABSTRACT

An examination table includes a base portion and a table portion with a support surface having a backrest member. The backrest member includes an upper structural frame panel defining a first outer periphery, and a lower structural frame panel defining a second outer periphery. A plurality of fastener-less clinch joints is formed along the first outer periphery and the second outer periphery, thereby permanently coupling the upper structural frame panel and the lower structural frame panel. The backrest member may also include an upholstery layer substantially covering the upper structural frame panel, the first outer periphery, and the second outer periphery.

### TECHNICAL FIELD

This invention relates generally to examination tables for medical procedures, and more specifically, to a table back assembly and method of assembly.

### BACKGROUND

Examination tables are incorporated in medical offices for supporting and positioning a patient undergoing a medical procedure or examination. Conventional examination tables include a base and a support surface mounted on the base. In order to provide a more comforting support arrangement for the patient, the support surface may include a seat portion and a backrest portion that pivots with respect to the seat portion. Thus, the support surface can be moved from a chair position where the support surface resembles a chair to an examination position where the support surface resembles a substantially flat and elevated examination table, depending upon the current needs of the patient and user.

Conventional examination tables also typically include an actuation system for moving the support surface and the backrest portion. The support surface is moved vertically by a scissor lift or another lifting mechanism incorporated into the base of the examination table. The backrest portion of the support surface may be pivoted with respect to the seat portion with a lift cylinder or another similar drive mechanism. The lifting and drive mechanisms of the actuation system are independently driven by electric motors, hydraulic motors, or other types of motors. Conventional examination tables also include a control system operatively connected to hand-operated and/or foot-operated control panels provided on the examination table. The control system receives input from the control panels and then activates the motors of the actuation system to move the support surface or the backrest portion.

The load rating for conventional examination tables is limited by the strength of the actuation system and the structural components of the support surface. Although the typical load rating for conventional examination tables has been maximized at about 400 pounds, improvements to the actuation system components are currently being developed that exceed these conventional capabilities. However, the conventional backrest portion formed by a single panel of steel continues to limit the load rating of conventional examination tables despite the advances in actuation systems. With the rapid rise of obesity worldwide, such a limited load rating for an examination table effectively prevents medical professionals from providing proper care to that segment of their patients. Consequently, it would be desirable to provide an examination table that overcomes these and other deficiencies.

### SUMMARY

The invention according to one embodiment includes an examination table having a base portion and a table portion. The table portion includes a support surface defined by a seat portion and a backrest portion that pivots with respect to the seat portion. The backrest portion includes an upper structural frame panel having a first outer periphery, and a lower structural frame panel having a second outer periphery. The upper structural frame panel and the lower structural frame panel are permanently coupled by a plurality of fastener-less clinch joints formed along the first outer periphery and the second outer periphery.

The upper structural frame panel further includes at least one connection bracket. The connection bracket extends in a direction perpendicular to a plane defined by the first outer periphery. The connection bracket couples to a drive mechanism for pivoting the backrest portion with respect to the seat portion. The lower structural frame member further includes a central aperture configured to receive the connection bracket when the upper structural frame panel and the lower structural frame panel are permanently coupled. The backrest portion also includes an upholstery layer forming the appearance of a chair backrest and substantially covering the upper structural frame panel, the first outer periphery, and the second outer periphery. The upper structural frame panel and the lower structural frame panel are formed from steel such that the backrest portion is configured to support loads up to 650 pounds.

In another embodiment of the invention, a method of forming a backrest member for an examination table includes aligning a first outer periphery of an upper structural frame panel with a second outer periphery of a lower structural frame panel. The method also includes positioning the upper structural frame panel and the lower structural frame panel within a die set. The die set includes a plurality of punches and a corresponding plurality of holes in a shaped die plate. The method further includes punching the first outer periphery and the second outer periphery into each of the plurality of die holes with the plurality of punches to form a plurality of fastener-less clinch joints, thereby permanently coupling the upper structural frame panel and the lower structural frame panel.

Neither of the first outer periphery and the second outer periphery shears when punched into the plurality of die holes to form the plurality of fastener-less clinch joints. Furthermore, the method may include forming each of the plurality of fastener-less clinch joints simultaneously.

### BRIEF DESCRIPTION OF THE DRAWINGS

The accompanying drawings, which are incorporated in and constitute a part of this specification, illustrate embodiments of the invention and, together with a general description of the invention given below, serve to explain the principles of the invention.

FIG. 1 is a perspective view of one embodiment of an examination table in accordance with the invention.

FIG. 2 is another perspective view of the examination table of FIG. 1, with a portion of the upholstery layer of the backrest portion cut away to illustrate the structural frame panels of the backrest portion.

FIG. 3 is a side view of the examination table of FIG. 1, illustrating portions of the actuation system and the structural frame panels of the backrest portion in phantom.

FIG. 4 is an exploded view of the structural frame panels of the backrest portion of FIG. 2.

FIG. 5 is a cross-sectional side view of a fastener-less clinch joint formed by the structural frame panels of the backrest portion of FIG. 2.

### DETAILED DESCRIPTION

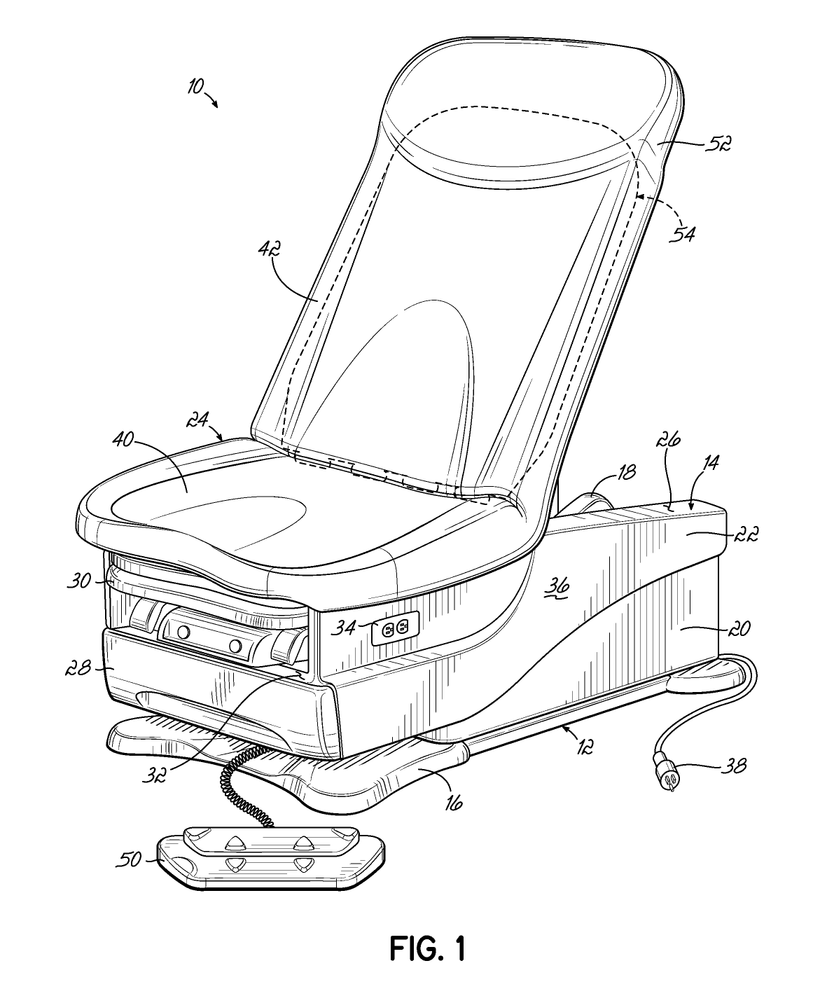

Referring to FIGS. 1-5, one embodiment of an examination table 10 is illustrated. The examination table 10 includes a base portion 12 and a table portion 14 disposed above the base portion 12. The base portion 12 includes a base member 16 for supporting the examination table 10 on a floor surface. The base member 16 forms a support footprint for the examination table 10 having an area substantially the same size as the table portion 14. The size of the support footprint improves the resistance against tipping of the examination table 10.

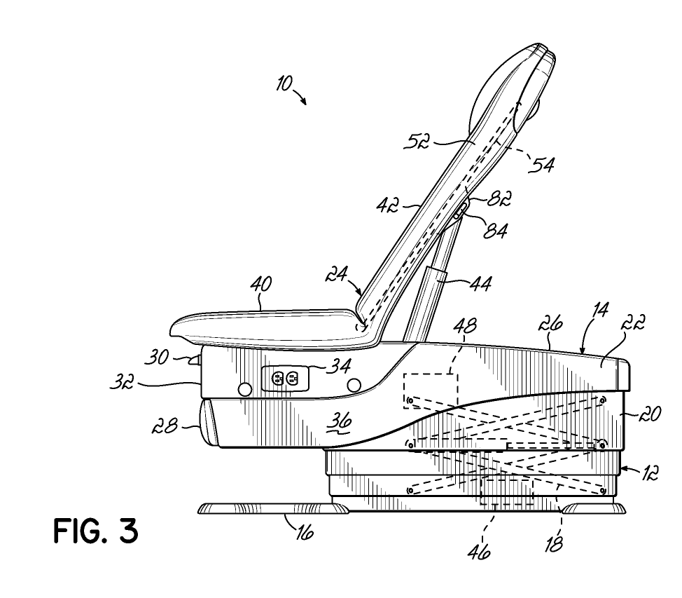

The base portion 12 also includes a scissor lift 18 (shown in phantom in FIG. 3) engaged with the base member 16 and the table portion 14. The scissor lift 18 is operable to move the table portion 14 generally upwardly and downwardly with respect to the base member 16. The scissor lift 18 and all other internal components of the base portion 12 are stored within a telescoping shell cover 20. The telescoping shell cover 20 telescopes outwardly from the base member 16 to the table portion 14.

The table portion 14 further includes a table frame 22 and a support surface 24. The table frame 22 defines a generally planar upper surface 26 for supporting the support surface 24. The table frame 22 may also include a plurality of storage drawers 28 and retractable instrument pans 30 at a front surface 32 of the table frame 22. The storage drawers 28 and retractable instrument pans 30 provide convenient storage areas for a user such as a medical professional during patient examinations and procedures on the examination table 10.

The table frame 22 further includes at least one electrical outlet 34 positioned along a side surface 36 of the table frame 22. The electrical outlet 34 is powered by the power supply to the examination table 10 and permits convenient electrical power for accessory devices used with the examination table 10 or during a medical procedure. Advantageously, the electrical outlet 34 and an actuation system for the examination table 10 are all powered by a single power cable 38 to reduce the number of cords that could be tripped over when working around the examination table 10.

The support surface 24 is divided into a seat portion 40 and a backrest portion 42. The seat portion 40 is rigidly coupled to the upper surface 26 of the table frame 22 adjacent to the front surface 32. The backrest portion 42 extends behind the seat portion 40 and may be pivoted with respect to the seat portion 40. A lift cylinder 44 or similar device is engaged with the backrest portion 42 and the table frame 22 to pivot the backrest portion 42. The lift cylinder 44 and scissor lift 18 combine to form the actuation system for moving the examination table 10 through various positions. It will be appreciated that various other lifting mechanisms could be substituted for the scissor lift 18 and the lift cylinder 44 in other embodiments.

The actuation system of the examination table 10 also includes a first motor 46 operatively coupled to the scissor lift 18 and shown in phantom in FIG. 3. The first motor 46 drives the scissor lift 18 to move the table portion 14 and support surface 24 upwardly and downwardly with respect to the base member 16. The actuation system further includes a second motor 48 operatively coupled to the lift cylinder 44. The second motor 48 drives the lift cylinder 44 to pivotally move the backrest portion 42 of the support surface 24 with respect to the seat portion 40. The first and second motors 46, 48 are brushless direct current (DC) electric motors in the illustrated embodiment, but hydraulic motors or another type of motor may be used in other embodiments. The examination table 10 also includes a foot control panel 50 and/or a manual control panel (not shown) for controlling the first and second motors 46, 48 and the corresponding movement of the examination table 10.

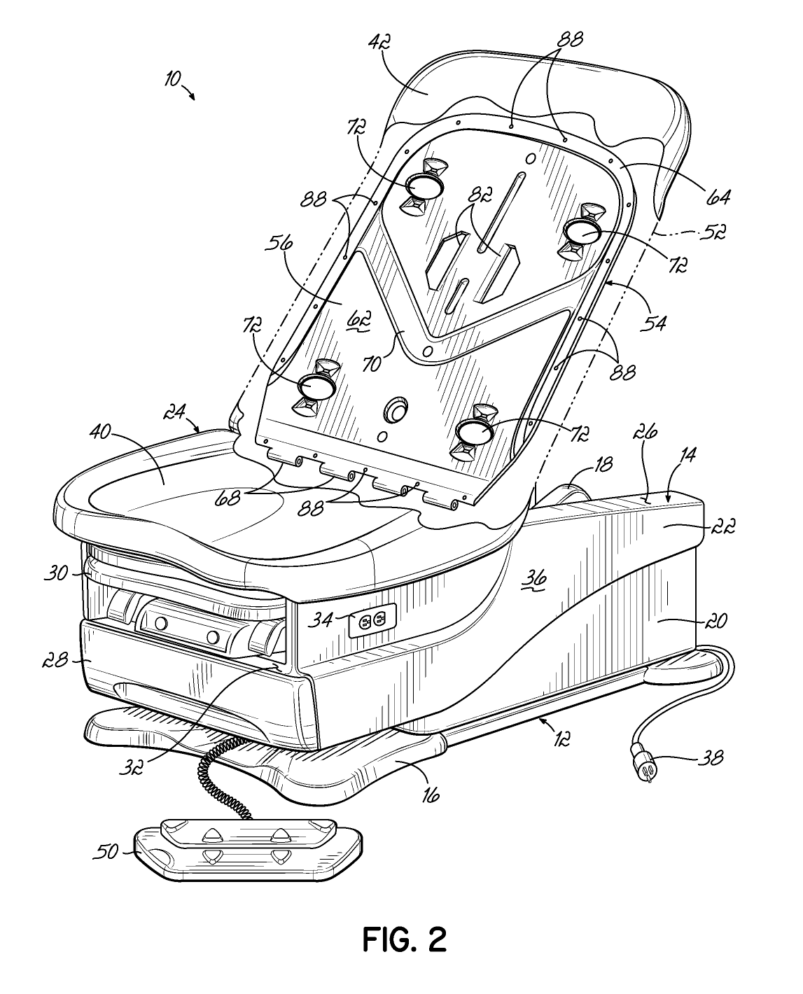

As shown in phantom in FIG. 1 and in the partially cut-away views of FIGS. 2 and 3, the backrest portion 42 of the examination table 10 includes an upholstery layer 52 and a structural layer 54. The structural layer 54 is operatively coupled to the lift cylinder 44. The upholstery layer 52 substantially covers the structural layer 54 to form the appearance of a chair backrest. Furthermore, the upholstery layer 52 is coupled to the structural layer 54 such that the upholstery layer 52 can be removed for replacement or cleaning when necessary.

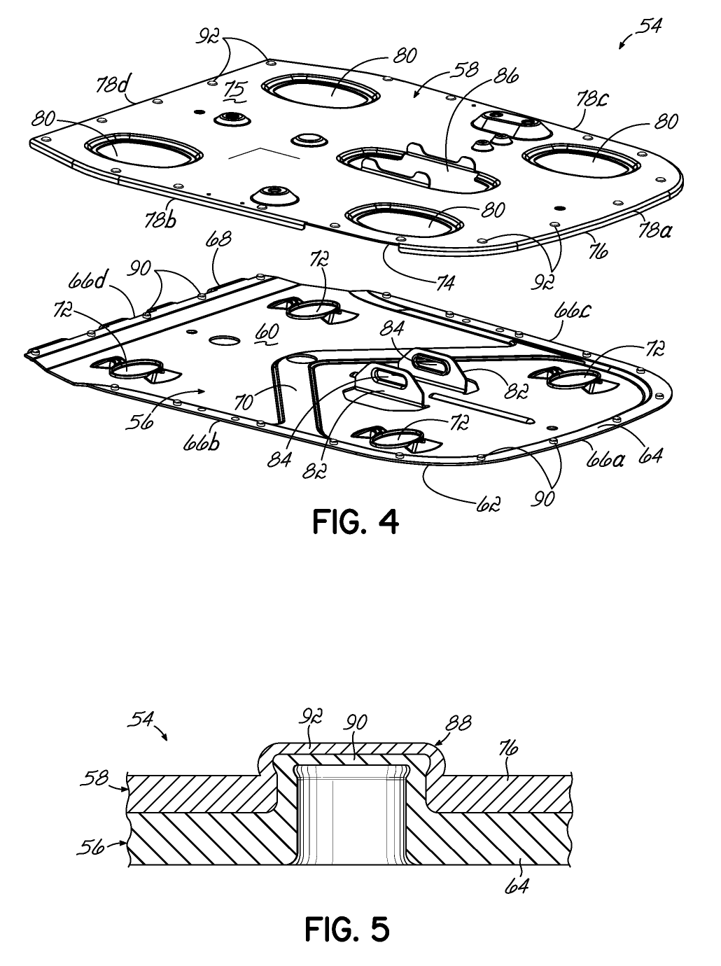

As discussed above, a conventional structural layer including only a single panel of formed steel is not strong enough to support patient loads over 400 pounds, which may be encountered with some obese patients. Consequently, the examination table 10 of the current embodiment includes a structural layer 54 formed by multiple panels of formed steel. More specifically, the structural layer 54 of the backrest portion 42 includes an upper structural frame panel 56 and a lower structural frame panel 58, as shown in exploded form in FIG. 4. Each of the upper structural frame panel 56 and the lower structural frame panel 58 is formed from steel to provide maximum strength and durability for the structural layer 54.

The upper structural frame panel 56 includes an interior side 60 and an exterior side 62 bounded by a first outer periphery 64. The first outer periphery 64 is raised slightly toward the interior side 60 from the remainder of the upper structural frame panel 56 so that the first outer periphery 64 can engage with the lower structural frame panel 58, as described in further detail below. The first outer periphery 64 is substantially rectangular in shape, defining a top edge 66a, side edges 66b, 66c, and a bottom edge 66d. The bottom edge 66d of the first outer periphery 64 includes a hinge connection 68 for coupling the backrest portion 42 to the seat portion 40 of the support surface 24. The upper structural frame panel 56 also has raised integral ribs 70 and/or apertures 72 formed to increase the strength and reduce the overall weight of the backrest portion 42.

The lower structural frame panel 58 also includes an interior side 74 and an exterior side 75 bounded by a second outer periphery 76. The interior side 74 of the lower structural frame panel 58 faces the interior side 60 of the upper structural frame panel 56. The second outer periphery 76 is raised slightly toward the interior side 74 from the remainder of the lower structural frame panel 58 such that the second outer periphery 76 can engage with the first outer periphery 64. The second outer periphery 76 is also substantially rectangular in shape, defining a top edge 78a, side edges 78b, 78c, and a bottom edge 78d corresponding respectively to the edges 66a, 66b, 66c, 66d of the first outer periphery 64. The lower structural frame panel 58 also includes raised integral ribs (not shown) formed to increase the strength and apertures 80 to receive upholstery locks (not shown).

As shown in FIG. 4, the upper structural frame panel 56 also includes a pair of connection brackets 82 extending away from the interior side 60 and generally perpendicular to the plane defined by the first outer periphery 64. Each of the connection brackets 82 includes an elongate slot 84. The lower structural frame panel 58 includes a central aperture 86 configured to receive the pair of connection brackets 82 when the upper structural frame panel 56 and the lower structural frame panel 58 are coupled. As shown most clearly in FIG. 2, the pair of connection brackets 82 extends beyond the exterior side of the lower structural frame panel 58 so that the lift cylinder 44 may be pivotally coupled to the connection brackets 82 through the elongate slots 84, which thereby prevent a zone where a user could be pinched during movement of the backrest portion 42.

The upper structural frame panel 56 and the lower structural frame panel 58 are permanently coupled by forming a plurality of fastener-less clinch joints 88 along the first outer periphery 64 and the second outer periphery 76. The embodiment of the examination table shown in FIG. 2 includes nineteen of the fastener-less clinch joints 88, but it will be appreciated that more or fewer clinch joints 88 may be formed. FIG. 5 illustrates a cross-section of one of the fastener-less clinch joints 88. The joint 88 is formed by aligning the first outer periphery 64 adjacent to the second outer periphery 76. Then a cylindrical portion 90 of the first outer periphery 64 is punched together with a cylindrical portion 92 of the second outer periphery 76 into a shaped die plate (not shown). The cylindrical portions 90, 92 are integral coplanar portions of the first and second outer peripheries 64, 76 prior to the punching motion. The punching motion deforms the cylindrical portions 90, 92 of the first and second outer peripheries 64, 76 into a button-style clinch joint 88 without shearing the material of either of the first and second outer peripheries 64, 76. Thus, the upper structural frame panel 56 and the lower structural frame panel 58 are permanently coupled.

Each of the fastener-free clinch joints 88 may be formed by a die set (not shown) having one punch and one corresponding hole in a shaped die plate. Alternatively, the plurality of fastener-free clinch joints 88 may be formed simultaneously by a die set (not shown) having a plurality of punches and plurality of corresponding holes in a shaped die plate. Consequently, the permanent coupling of the upper structural frame panel 56 and the lower structural frame panel 58 may be completed in one easily repeatable step for each examination table 10 to be manufactured. This one-step process to form 19 clinch joints 88 is much more efficient and just as structurally effective as spot-welding 19 welds between the first and second outer peripheries 64, 76.

The two-panel structural layer 54 of the examination table 10 is strong enough to withstand or support patient loads up to 650 pounds. In combination with the improved actuation system, the structural layer 54 increases the load rating such that a medical professional can effectively handle almost every conceivable patient on the examination table 10, from young children to the morbidly obese. Thus, the examination table 10 is advantageous for any medical professional to use daily in a hospital or medical office.

While the present invention has been illustrated by the description of the embodiment thereof, and while the embodiment has been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. An examination table, comprising:
a base portion; and
a table portion including a support surface having a seat portion and a backrest portion configured to pivot with respect to the seat portion,
wherein the backrest portion includes an upper structural frame panel defining a first outer periphery and a lower structural frame panel defining a second outer periphery, the upper structural frame panel and the lower structural frame panel being permanently coupled by a plurality of fastener-less clinch joints formed along the first outer periphery and the second outer periphery.

2. The examination table of claim 1, wherein the upper structural frame panel further comprises at least one connection bracket extending in a direction perpendicular to a plane defined by the first outer periphery, and wherein the at least one connection bracket is adapted to couple to a drive mechanism for pivoting the backrest portion with respect to the seat portion.

3. The examination table of claim 2, wherein the lower structural frame panel further comprises a central aperture adapted to receive the at least one connection bracket when the upper structural frame panel and lower structural frame panel are permanently coupled.

4. The examination table of claim 2, wherein the backrest portion further comprises an upholstery layer substantially covering the upper structural frame panel, the first outer periphery, and the second outer periphery, the upholstery layer forming the appearance of a chair backrest.

5. The examination table of claim 4, wherein the upholstery layer is removably coupled to the first outer periphery and the second outer periphery to enable replacement or cleaning of the upholstery layer.

6. The examination table of claim 1, wherein the upper structural frame panel and the lower structural frame panel are formed from steel.

7. The examination table of claim 6, wherein each fastener-less clinch joint is formed by punching a portion of the first outer periphery and a portion of the second outer periphery into a shaped die plate such that the first outer periphery and second outer periphery deform together into a button-style clinch joint without shearing either of the first outer periphery and second outer periphery.

8. The examination table of claim 1, wherein the backrest portion is configured to withstand or support loads up to 650 pounds.

9. A backrest member for an examination table, comprising:
an upper structural frame panel having a first outer periphery; and
a lower structural frame panel having a second outer periphery,
wherein the upper structural frame panel and the lower structural frame panel are permanently coupled with a plurality of fastener-less clinch joints formed along the first outer periphery and the second outer periphery

10. The backrest member of claim 9, wherein the upper structural frame panel further comprises at least one connection bracket extending in a direction perpendicular to a plane defined by the first outer periphery, and wherein the at least one connection bracket is adapted to couple to a drive mechanism for pivoting the backrest portion with respect to the seat portion.

11. The backrest member of claim 10, wherein the lower structural frame panel further comprises a central aperture adapted to receive the at least one connection bracket when the upper structural frame panel and lower structural frame panel are permanently coupled.

12. The backrest member of claim 10, further comprising:
an upholstery layer substantially covering the upper structural frame panel, the first outer periphery, and the second outer periphery, the upholstery layer forming the appearance of a chair backrest.

13. The backrest member of claim 12, wherein the upholstery layer is removably coupled to the first outer periphery and the second outer periphery to enable replacement or cleaning of the upholstery layer.

14. The backrest member of claim 9, wherein the upper structural frame panel and the lower structural frame panel are formed from steel.

15. The backrest member of claim 14, wherein each fastener-less clinch joint is formed by punching a portion of the first outer periphery and a portion of the second outer periphery into a shaped die plate such that the first outer periphery and second outer periphery deform together into a button-style clinch joint without shearing either of the first outer periphery and second outer periphery.

16. The backrest member of claim 9, wherein the backrest member is configured to withstand or support loads up to 650 pounds.

17. A method of forming a backrest member for an examination table, the method comprising:
aligning a first outer periphery of an upper structural frame panel and a second outer periphery of a lower structural frame panel;
positioning the upper structural frame panel and the lower structural frame panel within a die set having at least one punch and at least one corresponding hole in a shaped die plate; and
punching the first outer periphery and the second outer periphery into each of the plurality of die holes with the plurality of punches to form a plurality of fastener-less clinch joints and permanently couple the upper structural frame panel and the lower structural frame panel.

18. The method of claim 17, wherein punching the first outer periphery and the second outer periphery to form the plurality of fastener-less clinch joints does not shear either of the first outer periphery and the second outer periphery.

19. The method of claim 17, further comprising:
covering the upper structural frame panel, the first outer periphery, and the second outer periphery with an upholstery layer to form the appearance of a chair backrest.

20. The method of claim 17, wherein each of the plurality of fastener-less clinch joints is formed simultaneously by the die set having a plurality of punches and a plurality of corresponding holes in the shaped die plate.
